(19) United States
(12) Patent Application Publication
(10) Pub. No.: US 2014/0020649 A1
(43) Pub. Date: Jan. 23, 2014

(54) MULTI-DIRECTIONAL ASYMMETRIC SURFACES FOR HOUSINGS AND HOUSING COVERS AND INTERNAL COMBUSTION ENGINES COMPRISING THE SAME

(71) Applicant: GM GLOBAL TECHNOLOGY OPERATIONS LLC, Detroit, MI (US)

(72) Inventors: Eric D. Staley, Flushing, MI (US); David R. Staley, Flushing, MI (US)

(73) Assignee: GM GLOBAL TECHNOLOGY OPERATIONS LLC, Detroit, MI (US)

(21) Appl. No.: 13/850,682

(22) Filed: Mar. 26, 2013

Related U.S. Application Data
(60) Provisional application No. 61/673,526, filed on Jul. 19, 2012.

(51) Int. Cl. F02F 7/00

(52) U.S. Cl. CPC F02F 7/00
USPC 123/195 R

(57) ABSTRACT

In one embodiment, a housing is disclosed. The housing includes an asymmetric surface portion having a periphery, the asymmetric surface portion comprising a plurality of asymmetric surface sections disposed about the periphery, each asymmetric surface section having a surface contour differing from the surface contours of the other surface sections. In another embodiment, an engine front cover is disclosed. The engine front cover includes a substantially circular asymmetric surface portion disposed concentrically about a crankshaft bore, the asymmetric surface portion comprising a plurality of asymmetric surface sections disposed substantially concentrically about the crankshaft bore, each asymmetric surface section having a surface contour differing from the surface contours of the other surface sections.

### CROSS-REFERENCES TO RELATED APPLICATIONS

This patent application claims priority to U.S. Provisional Patent Application Ser. No. 61/673,526 filed Jul. 19, 2012, which is incorporated herein by reference in its entirety.

### FIELD OF THE INVENTION

The subject invention relates to housings incorporating asymmetric surface portions, and more particularly housing covers that incorporate asymmetric surface portions, and even more particularly engine front covers that incorporate asymmetric surface portions, as well as internal combustion engines that utilize such housings and covers.

### BACKGROUND

Various housings and housing covers, including the outer or inner surface, or both surfaces, of an engine front cover near the front crankshaft seal, incorporate flat-panels. These flat panels are subject to various incident pressure waves during operation of the engine, including those transmitted through the engine oil and those transmitted through the air space over the engine oil, or a combination thereof. These pressure waves can create an “oil canning” mode, wherein the front cover of the engine itself becomes a source of noise, vibration or harshness (NVH) due to incident pressure waves, or the cover otherwise amplifies or reinforces incident pressure waves within the engine that originate at other sources and impinge upon the outer or inner surfaces of the front cover.

Various solutions have been offered to address this problem, including the addition of structural ribbing to increase the stiffness of the engine front cover near the front crankshaft seal; however, the ability to use this approach is limited due to the fact that this region of the engine is very crowded and the space envelope available for the front cover is limited. Thus, the ability to incorporate structural ribs to stiffen the engine front cover is also limited. NVH damping pads have also been added to the engine front cover to address this problem, but have a limited ability to attenuate all of the “oil canning” modes resulting from the incident pressure waves, as these pads are typically designed to damp or attenuate specific frequencies and must be applied at a predetermined location in order to damp the frequency(ies) for which they are designed. NVH damping pads also increase the cost of the front covers to which they are applied due to the material and labor costs associated with making them and the labor necessary to install them.

Accordingly, it is desirable to provide housings, and more particularly housing covers, including engine front covers, which have improved NVH performance by reducing the propensity of the housings to contribute to NVH during operation of the devices, such as internal combustion engines, with which they are employed.

### SUMMARY OF THE INVENTION

In one exemplary embodiment, a housing is disclosed. The housing includes an asymmetric surface portion having a periphery, the asymmetric surface portion comprising a plurality of asymmetric surface sections disposed about the periphery, each asymmetric surface section having a surface contour differing from the surface contours of the other surface sections.

In another exemplary embodiment, an engine front cover is disclosed. The engine front cover includes a substantially circular asymmetric surface portion disposed concentrically about a crankshaft bore, the asymmetric surface portion comprising a plurality of asymmetric surface sections disposed substantially concentrically about the crankshaft bore, each asymmetric surface section having a surface contour differing from the surface contours of the other surface sections.

In yet another exemplary embodiment, an internal combustion engine is disclosed. The internal combustion engine includes an engine block having a rotatable crankshaft disposed therein. The internal combustion engine also includes an engine front cover sealingly disposed on a front end of the engine block, the front cover comprising a substantially circular asymmetric surface portion disposed concentrically about a crankshaft bore, the asymmetric surface portion comprising a plurality of asymmetric surface sections disposed substantially concentrically about the crankshaft bore, each asymmetric surface section having a surface contour differing from the surface contours of the other surface sections.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a perspective view of an exemplary embodiment of an outer surface of a housing as disclosed herein;

FIG. 2 is a perspective view of the inner surface of the housing of FIG. 1;

FIG. 3 is a perspective view of a second exemplary embodiment of an outer surface of a housing as disclosed herein;

FIG. 4 is a perspective view of the inner surface of the housing of FIG. 3;

FIG. 5 is a perspective view of a third exemplary embodiment of an outer surface of a housing as disclosed herein;

FIG. 6 is a perspective view of the inner surface of the housing of FIG. 5;

FIG. 7 is a perspective view of a fourth exemplary embodiment of an outer surface of a housing as disclosed herein; and

FIG. 8 is a perspective view of the inner surface of the housing of FIG. 7.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

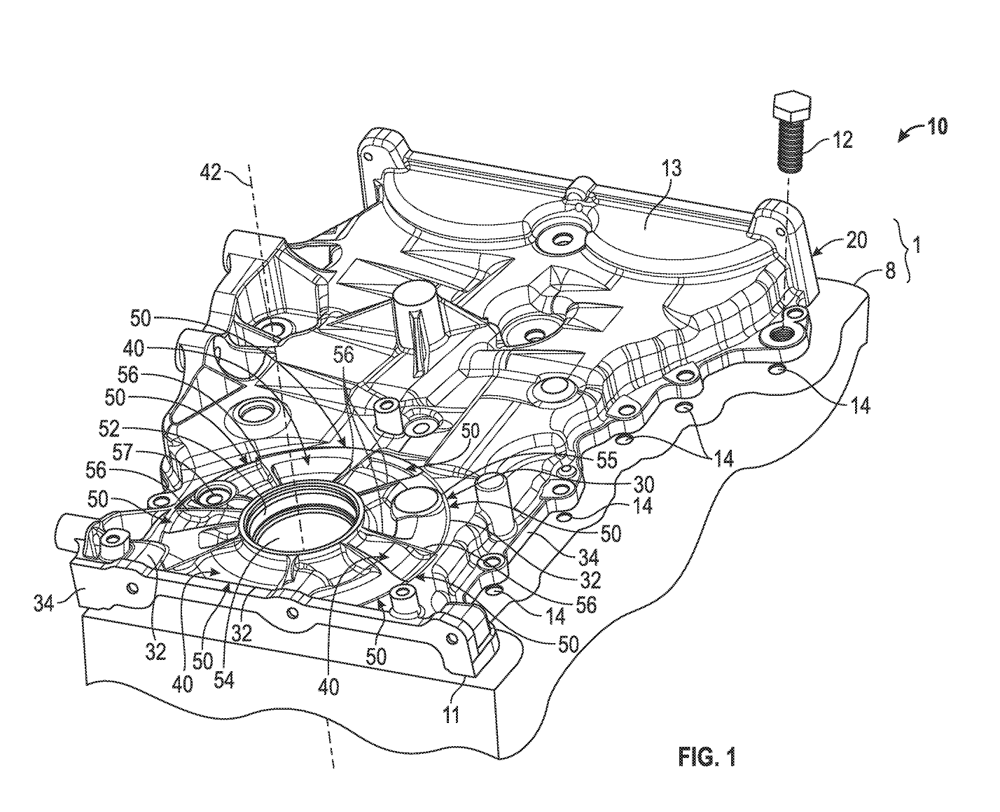

In accordance with the exemplary embodiments of FIGS. 1-8, a housing 10 is disclosed. The housing 10 includes an asymmetric surface 40 on the housing that provides increased structural stiffness and prevents, or significantly reduces, panel resonances, which results in a reduction in radiated noise and NVH attributable to the housing as compared to a similar housing that does not include the asymmetric surface 40. The housings 10 disclosed herein may provide reduced weight as compared to a similar housing without the asymmetric surface that may require increased wall thicknesses to provide a comparable increase in stiffness and damping performance. The housings 10 disclosed herein may also enable use of the housing without the addition of NVH damping pads, which provide a cost reduction, as well as increased strength and/or durability because the stronger housings are less susceptible to impact damage and degradation processes associated with application of cyclic stresses (i.e., fatigue and cyclic crack propagation).

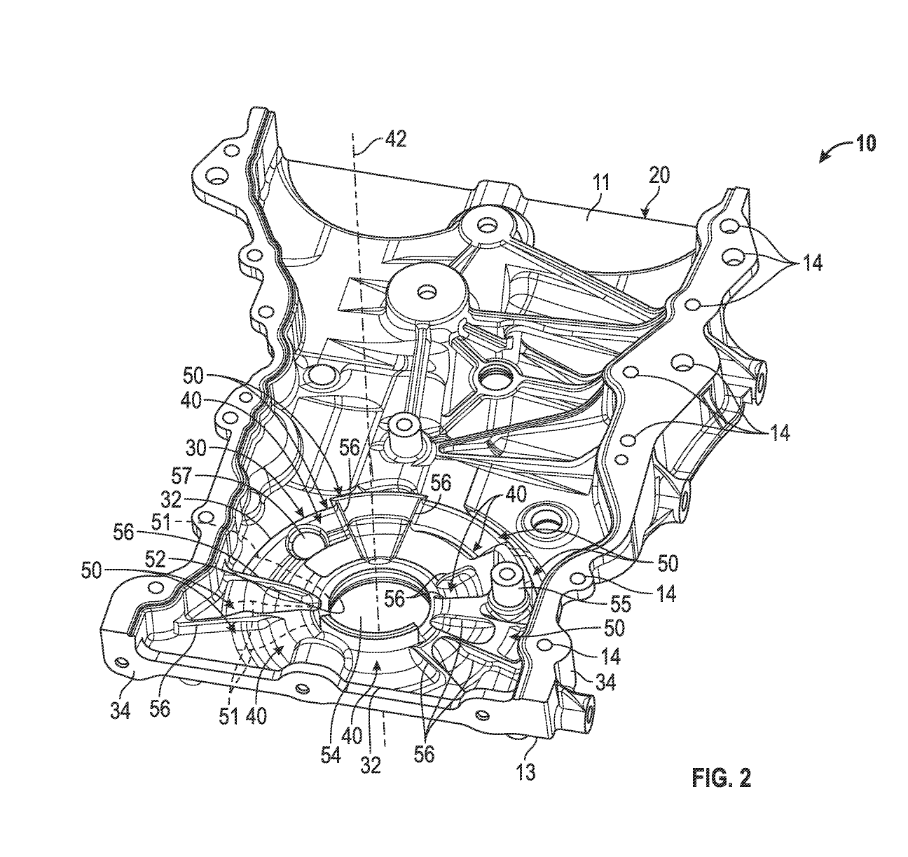

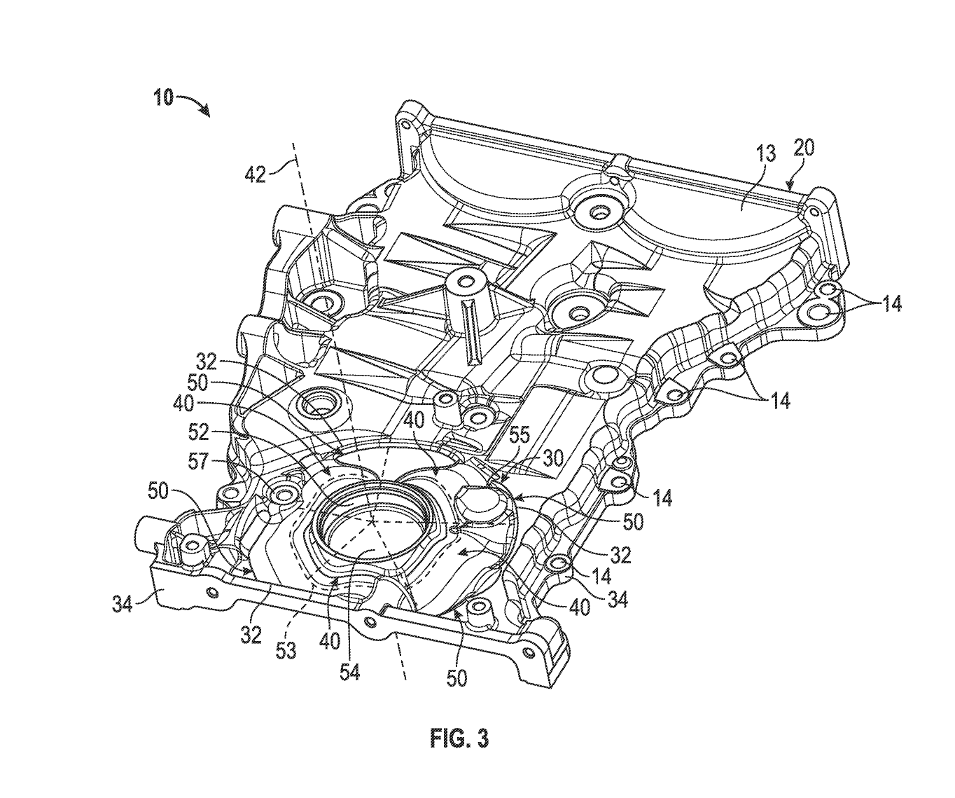

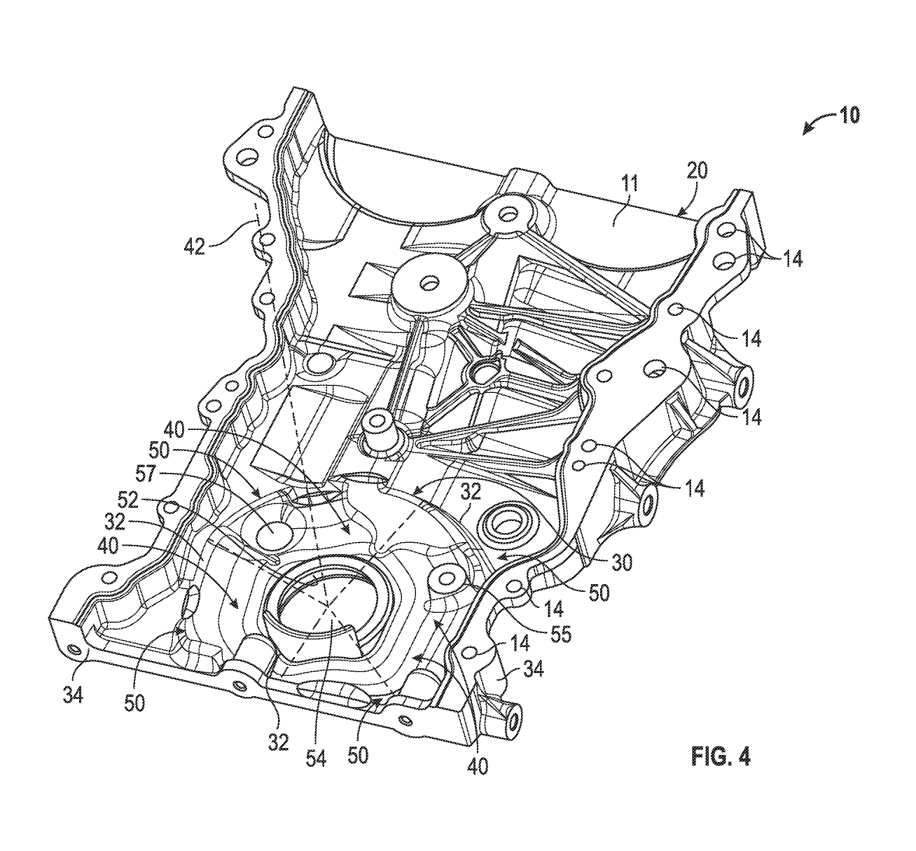

The housing 10 may include any suitable housing, particularly a housing having a surface, including an inner surface 11 or an outer surface 13 (or both), which is subject to incident pressure waves from a working fluid to which the surface(s) is exposed, particularly housings 10 that are susceptible to resonance and flexure of a surface, or portion of a surface, which is exposed to the incident pressure waves. The housing 10 may have any suitable shape or size, and may be used for any application. The housing 10 may also include a portion of a housing, such as a cover or lid, which may be detachably attached to the housing, such as by the use of a threaded fastener(s), such as a threaded bolt 12 and associated nut and/or threaded (e.g. FIGS. 1 and 2) or unthreaded (e.g. FIGS. 3 and 4) boss 14. In one embodiment, the housing 10 may include an engine front cover 20 that is configured for detachable attachment to the front of an engine block 8, wherein the front cover 20 and engine block 8 comprise an internal combustion engine 1.

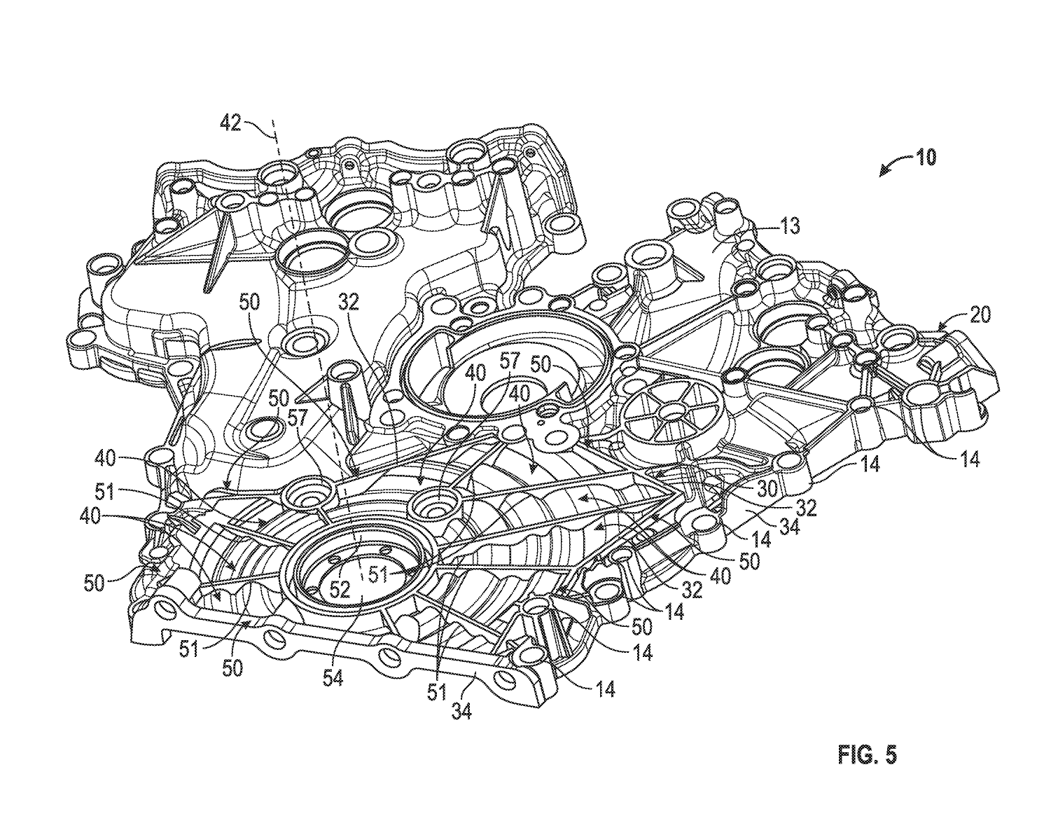

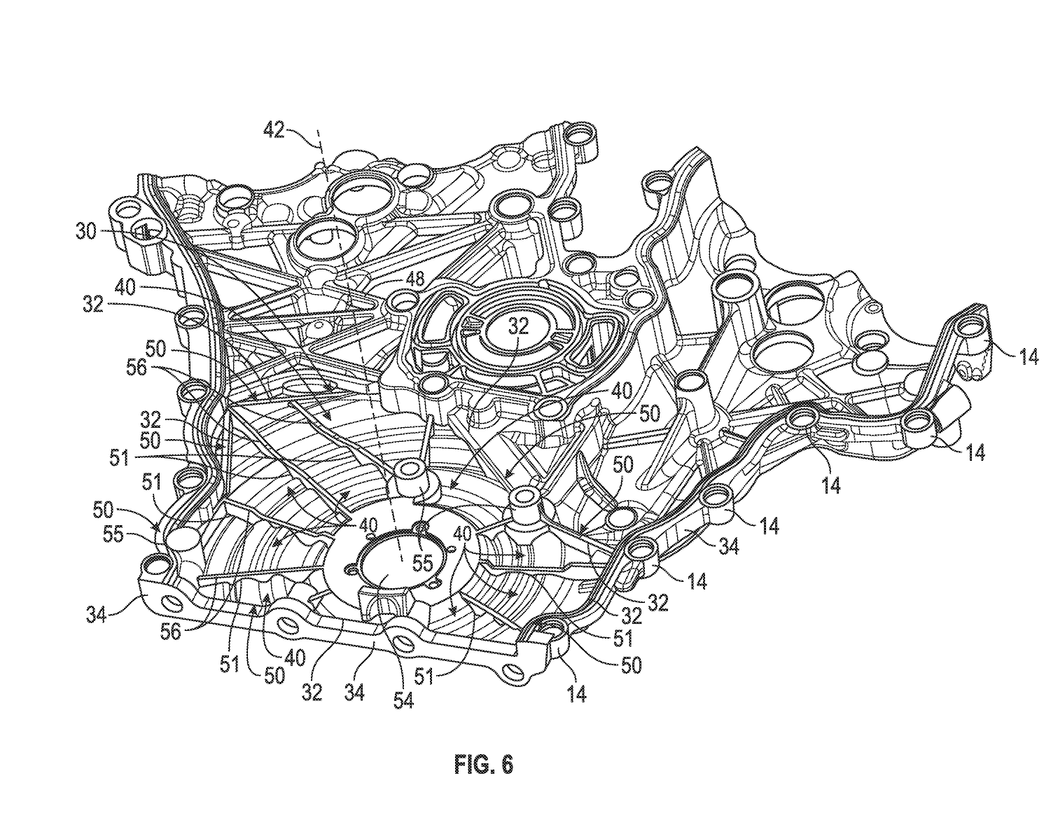

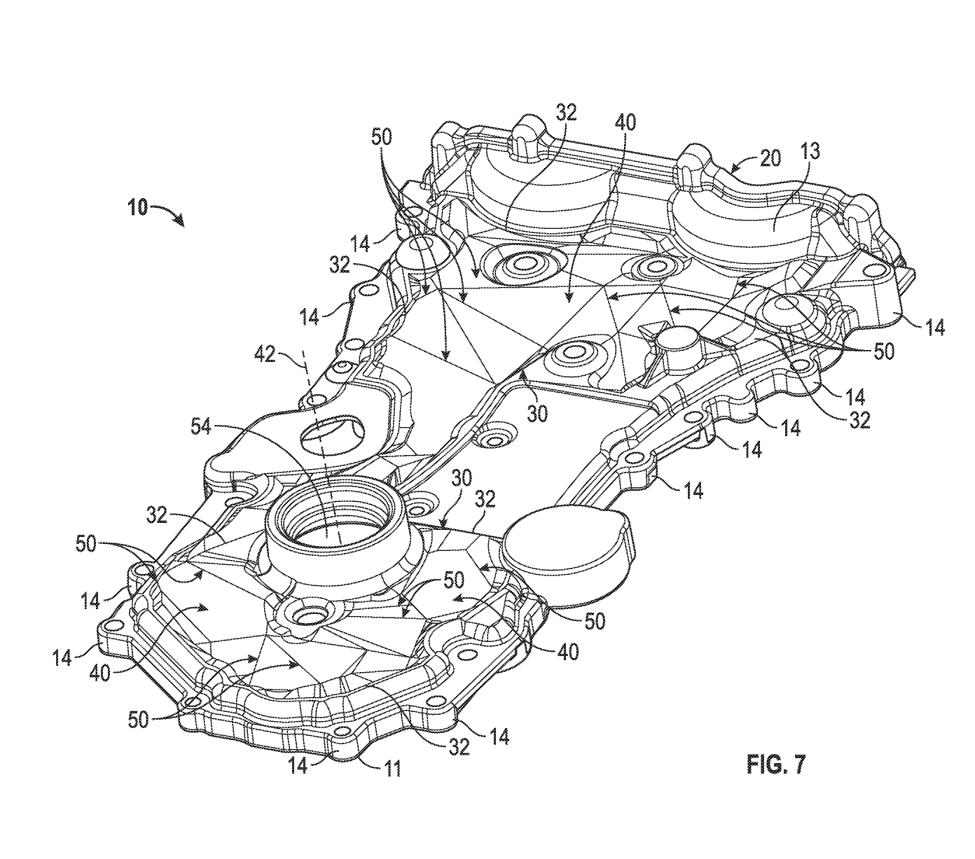

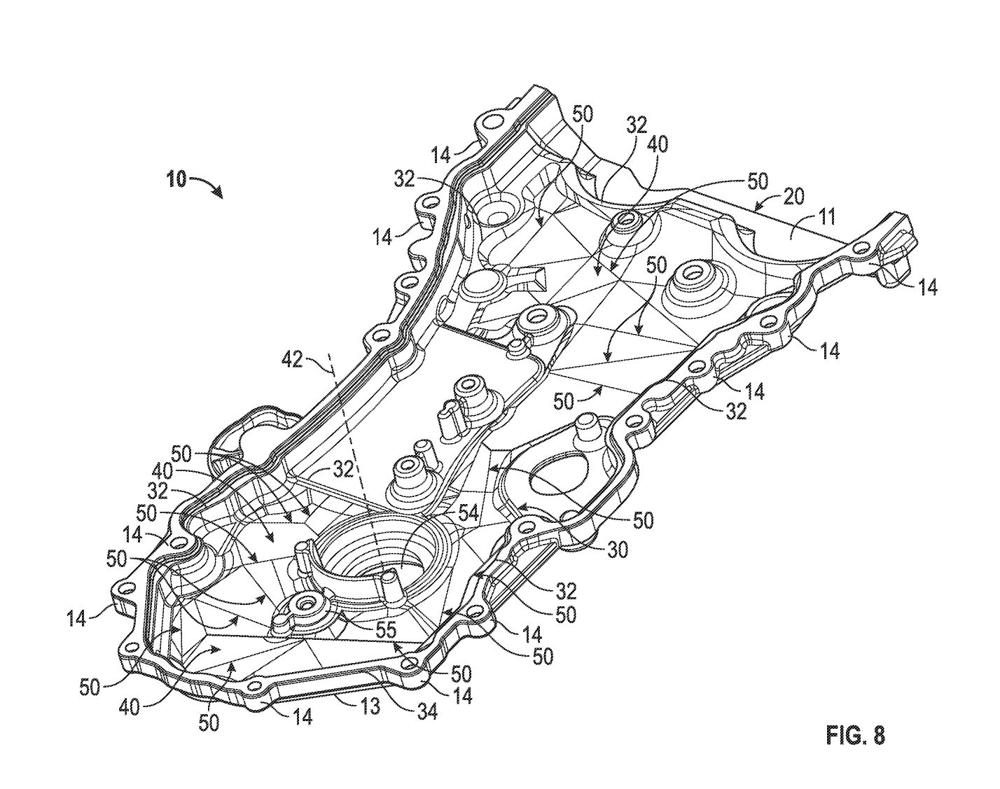

The housing 10, such as engine front cover 20, includes an asymmetric surface portion 30 (or a plurality of portions (FIGS. 7 and 8)) having a periphery 32. The periphery 32 defines the shape of the asymmetric surface portion 30. The periphery 32 may have any suitable shape and size. In one embodiment, the periphery has a substantially polygonal (e.g. FIGS. 5-8) or curved shape (e.g. FIGS. 1-4), or a combination thereof. Polygonal shapes include both regular and irregular polygons, or combinations thereof, including triangular, rectangular, pentagonal, hexagonal, etc. shapes. Curved shapes include both regular and irregular curved shapes, or combinations thereof, including circular, elliptical, parabolic, hyperbolic, etc. shapes. Combinations of polygonal and curved shapes include outwardly and inwardly (e.g. hourglass) curved barrel shapes, for example. These are but a few of the shapes that may be used to define the periphery 32 and the shape of the asymmetric surface portion 30. As used in conjunction with the polygonal and curved shapes, the term “substantially” is intended to convey that these shapes may be used to describe the shape form even though a portion of the form may be interrupted by other features, such as a boss 55 or other protrusion or recess (e.g. a bore), formed in the surface, or truncated due to the intersection of the asymmetric surface portion 30 with an edge or edges of the housing 10. The term substantially includes, for example, the case where the periphery 32 is partially defined by a circular or otherwise curved arc that intersects one or more edges 34 of the housing 10. In the embodiments of FIGS. 1 and 2 and FIGS. 3 and 4, the periphery 32 includes a substantially circular shape form. In the embodiment of FIGS. 5 and 6, the periphery 32 includes a partially circular and partially polygonal shape form. In the embodiment of FIGS. 7 and 8, the periphery 32 includes a substantially polygonal shape form.

The asymmetric surface portion 30 defines an asymmetric surface 40. The asymmetric surface 40 may be asymmetrically disposed with regard to any fixed reference, including longitudinal axis 42. The asymmetry is not just bi-lateral or multi-lateral asymmetry about longitudinal axis 42, but is more extensive. The asymmetric surface portion 30 includes a plurality of asymmetric surface sections 50 or segments disposed about the periphery 32. The asymmetric surface sections 50 may have any suitable shape and may be disposed about the periphery 32 in any suitable manner. In the embodiments of FIGS. 1-6, the asymmetric surface sections 50 together define a substantially circular asymmetric surface 40, and may be described as a plurality of substantially circular sectors or pie-shaped sections. As used with circular sectors, the term “substantially” means that the circular sector or pie-shaped section may not comprise a circular opening 52, such as crankshaft opening 54.

Each asymmetric surface section 50 has a surface contour or shape differing from the surface contours or shapes of the other surface sections 50, including shape differences defined by a size difference of the section. For example, where the asymmetric surface sections 50 comprise substantially circular sectors, each of the substantially circular sectors may have a different circumferential size. That is, the length of the arc of each of the substantially circular sectors along the periphery 32 may be different. This is illustrated in FIGS. 1 and 2 where the substantially circular sectors defining asymmetric surface sections 50 are separated by a plurality of substantially raised ribs 56. The surface contours of the asymmetric surface sections 50, including the substantially circular sectors, may differ from one another radially, axially or circumferentially, or a combination thereof. The surface contours of the asymmetric surface sections 50, including the substantially circular sectors, differ from one another by at least two of a radial surface contour, a circumferential surface contour or an axial surface contour, and thus may be described as comprising multi-directional asymmetric surfaces, as they include asymmetric variations in the surface contour extending in more than one direction. This may include asymmetric variations in three directions, namely, axial, radial and peripheral or circumferential variations.

For example, in the embodiment of FIGS. 1-2 and 5-6, the surface contours of the substantially circular sectors each have a different radial surface contour and axial surface contour over the part of the axisymmetric surface portion 30 defined by the sector. In one embodiment, these differences in the radial surface contour and axial surface contour in each of the plurality of asymmetric surface sections 50, such as the plurality of circular sectors, include a plurality of asymmetric, radially-extending surface undulations 51 or a wave-like pattern that is unique or different from those of the other sectors, as illustrated in FIGS. 1-2 and 5-6.

In another example, in the embodiment of FIGS. 3 and 4, the surface contours of the substantially circular sectors each have a different circumferential surface contour and axial surface contour over the part of the asymmetric surface portion 30 defined by the sector. In one embodiment, these differences in the circumferential surface contour and axial surface contour in each of the plurality of asymmetric surface sections 50, such as the plurality of circular sectors, include a plurality of asymmetric, circumferentially-extending surface undulations 53 or a wave-like pattern that is unique or different from those of the other sectors, as illustrated in FIGS. 3 and 4.

In yet another example, in the embodiment of FIGS. 7 and 8, the surface contours of the plurality of asymmetric surface sections 50 are defined by a plurality of joined flat, planar polyhedrons, each polyhedron having a different planar orientation or direction, size and shape (e.g. number of sides) than the polyhedrons to which it is joined. The polyhedrons may be joined to provide asymmetric surface contours comprising a plurality of polygonal facets.

The housing 10, such as an engine front cover 20, may be made from any suitable material, including metals, ceramics, cermets, engineering plastics, and combinations or composites thereof. In one embodiment, the housing 10 may be formed from a metal, including aluminum or an aluminum alloy, and more particularly may formed as a cast aluminum component. A metal housing 10 may have any suitable predetermined thickness. In certain embodiments, the thickness of the housing 10 may be a substantially uniform thickness and the asymmetric surface portion 30 may be formed on the inner surface 11 of the housing, and due to the substantially uniform thickness may be present on the outer surface 13 as a negative image, i.e. convex curved surface contours on the inner surface forming corresponding concave surface contours on the outer surface 13. Similarly, the asymmetric surface portion 30 may be formed on the outer surface 13 of the housing, and due to the substantially uniform thickness may be present on the inner surface 11 as a negative image, i.e. convex curved surface contours on the outer surface 13 forming corresponding concave surface contours on the inner surface 11. In one embodiment, a housing 10, including an engine front cover 20, formed from cast aluminum or an aluminum alloy may have a thickness of about 2 mm to about 8 mm, and more particularly about 3 mm to about 6 mm, and even more particularly about 3 to about 4 mm. The housing 10 may also comprise an engineering thermoplastic, including an engineering thermoplastic composite, such as an engineering thermoplastic fiber composite, where strengthening fibers may be incorporated as continuous fibers, discontinuous fibers, tows, felts, woven or non-woven fabrics and the like. The fibers may be formed from any suitable fiber materials, including metal, polymer, ceramic, mineral, carbon fiber materials and the like. In one embodiment, a housing 10, including an engine front cover 20, formed from an engineering plastic may have a thickness of about 2 mm to about 5 mm, and more particularly about 2 mm to about 3 mm, and even more particularly about 2.5 mm.

Without being limited by theory, the asymmetric surface sections 50 are configured to reflect a coherent incident wave front and produce an incoherent wave front. In another aspect, the asymmetric surface sections 50 are configured to prevent resonance or amplification of incident wave fronts and prevent “oil canning” modes from being established on the interior or exterior of the housing 10.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A housing comprising an asymmetric surface portion having a periphery, the asymmetric surface portion comprising a plurality of asymmetric surface sections disposed about the periphery, each asymmetric surface section having a surface contour differing from the surface contours of the other surface sections.

2. The housing of claim 1, wherein the housing comprises a housing cover.

3. The housing of claim 2, wherein the housing cover comprises a front cover of an internal combustion engine.

4. The housing of claim 1, wherein the periphery has a substantially polygonal or curved shape, or a combination thereof.

5. The housing of claim 1, wherein the periphery is substantially circular.

6. The housing of claim 5, wherein the plurality of asymmetric surface sections are defined as substantially circular sectors.

7. The housing of claim 6, wherein the substantially circular sectors each has a different circumferential size.

8. The housing of claim 6, wherein the plurality of asymmetric surface sections are separated by a plurality of substantially raised ribs.

9. The housing of claim 6, wherein the surface contours of the substantially circular sectors differ from one another radially, axially or circumferentially, or a combination thereof.

10. The housing of claim 6, wherein the surface contours of the substantially circular sectors differ from one another by at least two of a radial surface contour, a circumferential surface contour or an axial surface contour.

11. The housing of claim 6, wherein the surface contours of the substantially circular sectors have a different radial surface contour and axial surface contour.

12. The housing of claim 11, wherein the different radial surface contour and axial surface contour of each of the plurality of circular sectors comprises a plurality of asymmetric, radially-extending surface undulations.

13. The housing of claim 6, wherein the surface contours of the substantially circular sectors have a different radial surface contour, axial surface contour and circumferential surface contour.

14. The housing of claim 13, wherein the different radial surface contour, axial surface contour and circumferential surface contour of each of the plurality of circular sectors comprises a plurality of asymmetric, circumferentially-extending surface undulations.

15. The housing of claim 1, wherein the surface contours of the plurality of surface sections are defined by a plurality of joined flat, planar polyhedrons, each polyhedron having a different planar orientation than the polyhedrons to which it is joined.

16. An engine front cover comprising a substantially circular asymmetric surface portion disposed concentrically about a crankshaft bore, the asymmetric surface portion comprising a plurality of asymmetric surface sections disposed substantially concentrically about the crankshaft bore, each asymmetric surface section having a surface contour differing from the surface contours of the other surface sections.

17. The engine front cover of claim 16, wherein the plurality of asymmetric surface sections are defined as substantially circular sectors or are separated by substantially raised ribs.

18. The engine front cover of claim 17, wherein each of the substantially circular sectors has a different circumferential size.

19. The engine front cover of claim 16, wherein the surface contour of each of the plurality of circular sectors comprises a plurality of asymmetric, circumferentially-extending surface undulations or a plurality of asymmetric, radially-extending surface undulations.

20. An internal combustion engine, comprising:
an engine block having a rotatable crankshaft disposed therein; and
an engine front cover sealingly disposed on a front end of the engine block, the front cover comprising a substantially circular asymmetric surface portion disposed concentrically about a crankshaft bore, the asymmetric surface portion comprising a plurality of asymmetric surface sections disposed substantially concentrically about the crankshaft bore, each asymmetric surface section having a surface contour differing from the surface contours of the other surface sections.
